(19) United States
(12) Patent Application Publication
(10) Pub. No.: US 2008/0197311 A1
(43) Pub. Date: Aug. 21, 2008

(54) ADJUSTABLE MECHANICAL DEVICE FOR CONTROLLING VALVE CLOSURE SPEED

(75) Inventors: Eric N. Combs, Goshen, IN (US); Todd B. Lozier, Elkhart, IN (US)

Correspondence Address: VAN DYKE, GARDNER, LINN & BURKHART, LLP, SUITE 207, 2851 CHARLEVOIX DRIVE, S.E., GRAND RAPIDS, MI, 49546, US

(73) Assignee: ELKHART BRASS MANUFACTURING COMPANY, INC., Elkhart, IN (US)

(21) Appl. No.: 12/029,066

(22) Filed: Feb. 11, 2008

Related U.S. Application Data
(60) Provisional application No. 60/900,888, filed on Feb. 12, 2007.

(51) Int. Cl. F16K 31/44

(52) U.S. Cl. 251/231

(57) ABSTRACT

An adjustable device for controlling closure of a valve closure member of a valve includes an adapter for mounting to a valve and an actuator for engaging the valve closure member, which is adapted to rotate about an axis for opening, closing or throttling the valve. The device also includes a slow close assembly that includes at least one friction member, which generates a friction force when the actuator is rotated to thereby limit the speed at which the handle may be rotated.

### CROSS REFERENCE TO RELATED APPLICATIONS

This application claims the benefit of U.S. provisional application Ser. No. 60/900,888, file Feb. 12, 2007, entitled ADJUSTABLE MECHANICAL DEVICE FOR CONTROLLING VALVE CLOSURE SPEED, which is incorporated by reference herein in its entirety.

### FIELD OF THE INVENTION

The present invention relates generally to actuator assemblies for valves and, more particularly, to valve actuator assemblies with slow close mechanisms.

### BACKGROUND OF THE INVENTION

The NFPA 1901 standard requires that any valve 3″ or greater in size used on a fire apparatus for water delivery (excludes tank to pump valves, etc) must be equipped with a control mechanism that keeps the valve from being closed in less than 3 seconds. This requirement is specifically targeted to eliminate the possibility of “water hammer,” should a valve be closed too quickly. Water hammer refers to a large volume of flowing water subjected to a rapid stop in flow, which generates a large and destructive shock wave through the piping system that generates a significant spike in water pressure that can cause normal devices to explode.

Types of slow close mechanisms presently in use include gear operator hand wheels (gear the valve so that the large number of revolutions required effectively limits a persons ability to complete the open/close process too quickly), electric (electronic controls monitor the speed of the open/close process to meet the requirement), and hydraulic devices.

Electric controls are highly effective, but expensive. Gear operator controls are less expensive, but it is sometimes difficult to make the linkage work well. Hydraulic devices are the least expensive option to meet the NFPA standards and are easily adapted for the large variety of valves operated by push-pull style actuators.

Some slow close mechanisms rely on fluid flow through a restrictive orifice to control the speed at which a handle shaft of a valve system can be turned. However, such a device does not allow for the handle to be repositioned without removal and repositioning of the device. Another issue with this type of device is that it is subject to breakdown over time, fluid contamination, and variation with fluid temperature which can affect the actual operation of the safety device. Such a device also has a limited travel, i.e. it has internal stops. Consequently, the internal stops of the device must be properly aligned with the mechanical stops of the valve body for proper operation. Also, any air that gets trapped in the slow close device during assembly and/or gets into the device during operation will significantly alter the “slow close” control level of the fluid flowing through the restrictive orifice. It is much easier to protect against the ingress of water or contamination than it is to protect against the ingress of air.

### SUMMARY OF THE INVENTION

The present invention provides an adjustable mechanical device for controlling valve closure that can meet or exceed NFPA standards for slow close. Further, the device is adapted to be installed such that it is completely sealed from the elements. The device may be constructed without any internal stops, which eliminates the need to align any internal stops with the valve stops required by conventional closure devices.

According to one form of the invention, an adjustable device for controlling closure of a valve closure member of a valve includes an adapter for mounting to a valve and an actuator for engaging the valve closure member, which is adapted to rotate about an axis for opening, closing or throttling the valve. The device also includes a slow close assembly that includes at least one friction member, which generates a friction force when the actuator is rotated to thereby limit the speed at which the handle may be rotated.

In one aspect, the device includes a handle, which is coupled to the actuator.

In another aspect, the friction member comprises a friction disc. Preferably, the slow close assembly comprises a plurality of friction discs. Further, the slow close assembly may comprise a resilient disc, such as a rubber disc, positioned adjacent the friction disc, wherein the friction generated by the friction disc may be adjusted by the resilient disc.

According to yet another aspect, the slow close assembly is mounted independent of internal mechanical stops, wherein the slow close mechanism can have a range of motion of without interference with any internal mechanical stops and for example have a range of motion greater than 270° or more.

According to one form of the invention, a valve includes a valve body with a passageway, a valve closure member in the passageway, which is mounted for movement between a closed position wherein the valve closure member blocks flow though the passageway and an open position wherein the passage is open for fluid flow, and an actuator, which engages the valve closure member. A slow close assembly is provided which includes a housing having a chamber and at least one friction member retained in the chamber. The friction member is coupled to the actuator, with the friction member generating a friction force in the chamber when the actuator is moved to thereby limit the speed at which the actuator may be moved.

In one aspect, the friction member comprises a friction disc. Optionally, the slow close assembly may include a plurality of friction discs. Further, a resilient disc may be provided and positioned adjacent the friction disc, wherein the friction generated by the friction disc may be adjusted by the resilient disc. For example, the resilient disc may comprise a rubber disc.

In other aspects, the slow close assembly is configured without internal mechanical stops, wherein the slow close mechanism is adapted to rotate independent of any internal mechanical stops.

In another aspect, the slow close assembly is a scaled assembly.

In another form of the invention, a valve includes a valve body with a passageway, a valve closure member in the passageway, and an actuator, which engages the valve closure member, as noted above. The valve further includes a slow close assembly, which includes a housing having a fluidly sealed chamber that is adapted to provide resistance to the movement of the actuator to thereby limit the speed at which the actuator may be moved.

In one aspect, the chamber is configured without internal stops.

In other aspects, the slow close assembly includes at least one friction member in the chamber coupled to the actuator, which is adapted to generate friction when the actuator moves to thereby provide resistance to the movement of the actuator.

In yet another form of the invention, a valve includes a valve body with a passageway, a valve closure member in the passageway, and an actuator engaging the valve closure member, as noted above. The assembly further includes a slow close assembly that includes a housing with a chamber that is adapted to provide resistance to the movement of the actuator to thereby limit the speed at which the actuator may be moved. Further, the slow close assembly is configured without any internal stops.

In other aspects, the slow close assembly includes at least one friction member in the chamber coupled to the actuator, which is adapted to generate friction when the actuator moves to thereby provide resistance to the movement of the actuator.

Optionally, a plurality of the friction members are provided in the chamber. Further, a resilient member may be positioned adjacent the friction member, wherein the friction generated by the friction member may be adjusted by the resilient member.

These and other objects, advantages, purposes and features of the present invention will become apparent upon review of the following specification in conjunction with the drawings.

### BRIEF DESCRIPTION OF THE DRAWINGS

FIG. 1 is a side elevation view of a valve actuator assembly of the present invention;

FIG. 2 is a top plan view of the valve actuator assembly of FIG. 1;

FIG. 2A is an elevation view of a valve with the valve actuator assembly of FIG. 1 mounted to the valve;

FIG. 2B is a cross-section taken along line IIB-IIB of FIG. 2A;

FIG. 3 is a cross-section view taken along III-III of FIG. 1;

FIG. 4 is an exploded perspective view of the valve actuator assembly;

FIG. 5 is an elevation view of another embodiment of the valve of the present invention;

FIG. 6 is a top plan view of the valve actuator assembly of FIG. 4;

FIG. 7 is a cross-sectional view taken along VII-VII of FIG. 5;

FIG. 8 is a side elevation view of a third embodiment of a valve actuator assembly of the present invention;

FIG. 9 is a top plan view of the valve actuator assembly of FIG. 8;

FIG. 10 is a left side elevation view of the valve actuator assembly of FIG. 8; and

FIG. 11 is a cross-section view taken along line XI-XI of FIG. 8.

### DESCRIPTION OF THE PREFERRED EMBODIMENTS

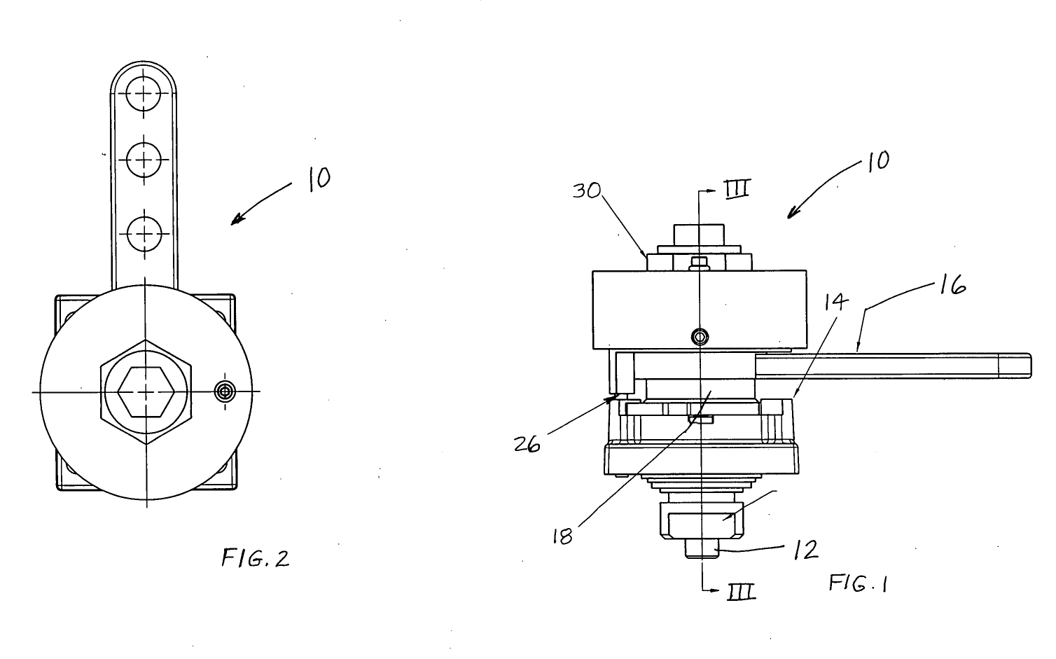

Referring to FIG. 1, the numeral 10 generally designates a valve actuator assembly of the present invention. As will be more fully described below, the valve actuator assembly of the present invention incorporates a slow close mechanism (15), which may be constructed without internal mechanical stops and provides control over the speed of the valve without reliance on a fluid, normally associated with conventional devices. Further, the slow close mechanism allows the control over the speed to be adjusted.

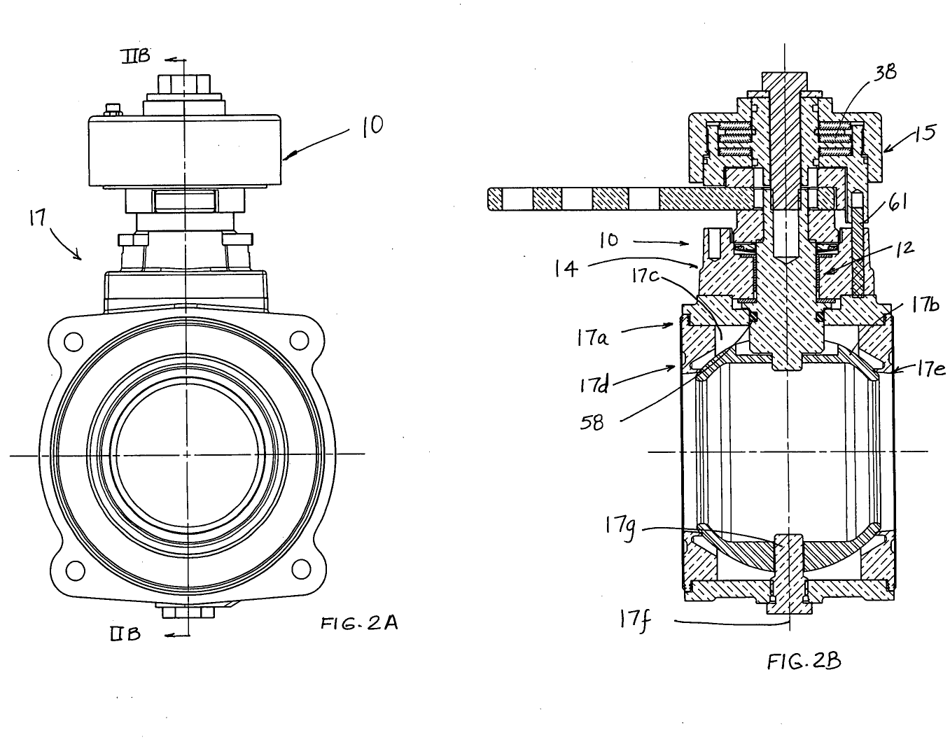

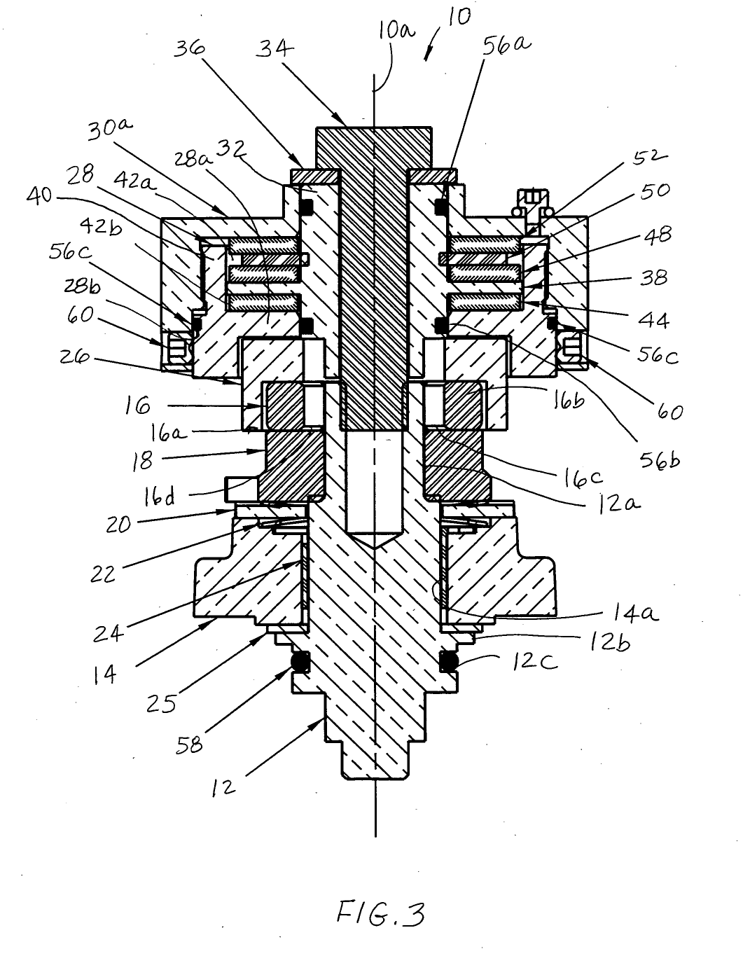

As best seen in FIG. 3, valve actuator assembly 10 comprises a manual actuator assembly and includes an actuator 12, an adapter 14, which permits the valve actuator assembly to be mounted to a valve 17 (FIGS. 2A and 2B), and a handle 16. Handle 16 is mounted to the upper end 12a of actuator 12 so that when the handle is rotated about axis 10a, actuator 12 will similarly rotate about axis 10a to thereby open, close, or throttle valve 17 to which the actuator assembly is mounted, typically a ball valve.

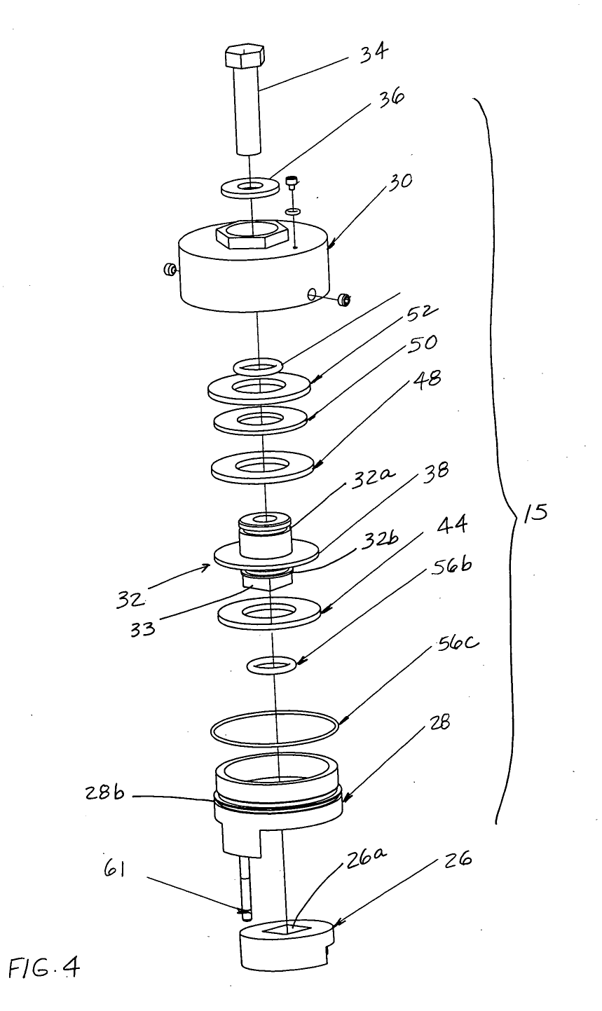

Ball valve 17 includes a housing 17a and a valve ball 17b, which is located in passageway 17c of housing 17a and, further, captured therein by a pair of valve seats 17d and 17e, which form a pair of opposed valve seat sealing surfaces (FIG. 4) for valve 17. To close the valve, therefore, valve ball 17b is pivoted or swiveled about its vertical axis 17f on a pivot bolt 17g by actuator 12, which extends into and engages valve ball 17b. For further details of a suitable valve, reference is made to U.S. application, entitled VALVE WITH ACTUATION SUB-ASSEMBLY, filed Oct. 11, 2005, Ser. No. 11/247,791 (Attorney Docket No. ELK01 P-319), which is hereby incorporated by reference herein in its entirety. As will be more fully described below, the rotation of actuator 12 is limited by slow close mechanism 15, which relies on friction to limit the speed of rotation of the actuator and, hence, the handle.

As noted above, handle 16 is mounted to upper end 12a of actuator 12 and, further, mounted over a stop plate 18, which is positioned between handle 16 and a bearing brake 20, which is mounted over adapter 14 (FIG. 3). Trapped between bearing brake 20 and adapter 14 is a spring 22, which is captured in a recess 14a of adapter 14 and which urges actuator 12 upwardly as viewed in FIG. 3, which helps facilitate the assembly of the actuator assembly on the valve. Actuator 12 extends through a bore 14a in adapter 14, which includes a bushing 24, which provides a low friction surface between adapter 14 and actuator 12. Located at a lower medial portion of actuator 12 is an enlarged flange 12b, which bears against a washer 25 positioned between flange 12b and the lower facing side of adapter 14. In this manner, flange 12b provides a stop for actuator 12 in the vertical direction (as viewed in FIG. 3).

Handle 16 includes a collar 16a, which includes an annular wall 16c and a base wall 16d, which includes a non-circular opening. Upper portion 12a of actuator 12 has a non-circular cross-section so that when extended through opening 12d of handle 16 rotatably couples handle 16 to the actuator. In this manner, as noted, when handle 16 is rotated about axis 10a so too is actuator 12.

Collar 16a of handle 16 is housed in slow close mechanism 15, which is mounted over collar 16a. Slow close mechanism 15 includes a plurality of nested annular members 26, 28, and 30, which are secured together by sets screws 60 (FIG. 3) (which secure annular member 30 to annular member 28) and by a pin 61, which extends between and secures member 28 to adapter 14. Annular members 26, 28, and 30 are mounted to the upper end 12a of actuator 12 by a coupler 32, which is secured to upper end 12a of actuator 12 by an elongated bolt 34 and washer 36, and provide an annular space or chamber, which is adapted to provide resistance to the rotation of actuator 12 about axis 10a, described more fully below.

Coupler 32 includes a generally cylindrical body but with a non-circular cross-section at its lower end 33. Lower end 33 inserts into a non-circular opening 26a provided in upper wall 26b of member 26 to thereby rotatably couple member 26 to coupler 32. Further, coupler 32 includes an annular flange 38 that extends radially outward. Flange 38 extends into the annular space to the upstanding wall 40 of member 28 but is spaced from lower wall 28a of member 28 and upper wall 30a of member 30 to thereby form annular spaces 42a and 42b between flange 38 and the upper wall 30a of member 30 and between flange 38 and lower wall 28a of member 28. Positioned in annular spaces 42a and 42 are friction discs 44, 48, and 52. Discs 44, 48, and 52 comprise annular discs and further are optionally formed from a non-sacrificial material for an extended life. As would be understood, the discs provide rotational friction between flange 38 and wall 28a of member 28 and between flange 38 and wall 30a, which provides rotational friction to actuator 12 about axis 10a. Therefore, discs 44, 48, and 52 provide resistance to the rotation of the actuator about axis 10a.

Optionally located between discs 48 and 52 is a washer that provides cushioning, such as a resilient washer, including a rubber disc. Incorporation of a rubber disc positioned between or “sandwiched” between the friction discs provides a wide range of adjustability with respect to controlling the handle and increased adjustment sensitivity. In other words, the rubber washer may be used to increase the resistance to the rotation of the actuator.

When assembled, therefore, the friction discs form a stack of friction discs that provide drag, which limits the speed at which the valve handle can be actuated and further which can be adjusted.

As noted above, assembly 10 is adapted to be installed such that it is completely sealed from the elements. Preferably, coupler 32 includes at least two annular grooves 32a and 32b for receipt and positioning of O-ring seals 56a and 56b (FIGS. 3 and 4). Member 28 also includes an annular groove 28b (FIG. 4) for receipt and positioning of an o-ring seal 56c. Seals 56a, 56b, and 56c therefore, seal the slow close actuation assembly. In this manner, the chamber of the slow close mechanism is sealed. Additional seals (seal 58) may be provided about actuator 12 below flange 12b at recess 12c, which is used to seal the actuator in the valve (see FIG. 2B).

As noted above, set screws 60 (FIG. 3) are provided to secure annular member 30 to annular member 28 and further fix the relative compression between the various discs to lock-in the slow close setting of the slow close mechanism. Also, a cap screw 60a and seal 60b may be provided at wall 30a of member 30, which provides a vent mechanism that can be used during adjustment. For example, the vent may be opened to adjust the actuator and then closed after the adjustment is complete.

In this manner, actuator assembly 10 and slow close mechanism or device 15 may be formed without internal stops, which eliminates the need for alignment between internal stops and the valve stops, typically required in conventional valve closure devices. Further, the resistance to rotation, and hence the speed at which the closure device can be operated, may be varied as desired by simply changing the material of the rubber washer or eliminating the rubber washer or increasing or decreasing the number of discs, including rubber washers.

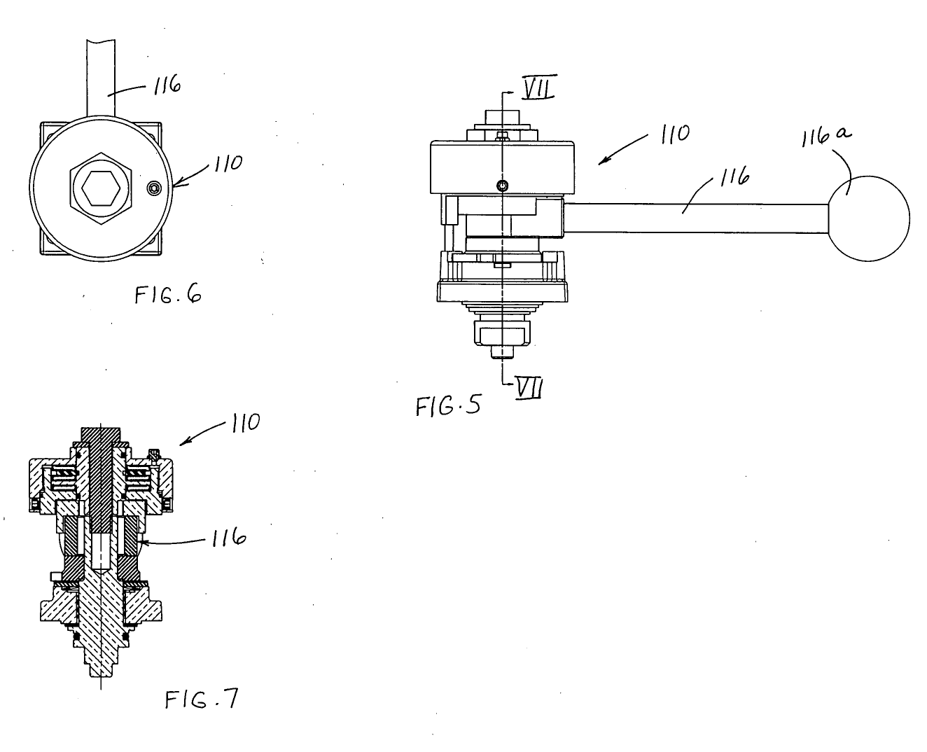

Referring to FIGS. 5-7, the numeral 110 generally designates another embodiment of the valve actuator assembly of the present invention. Actuator assembly 110 is of similar construction to actuator assembly 10 but includes a modified handle 116 with a knob 116a. For further details of the adapter assembly and slow close actuation assembly, reference is made to the previous embodiment.

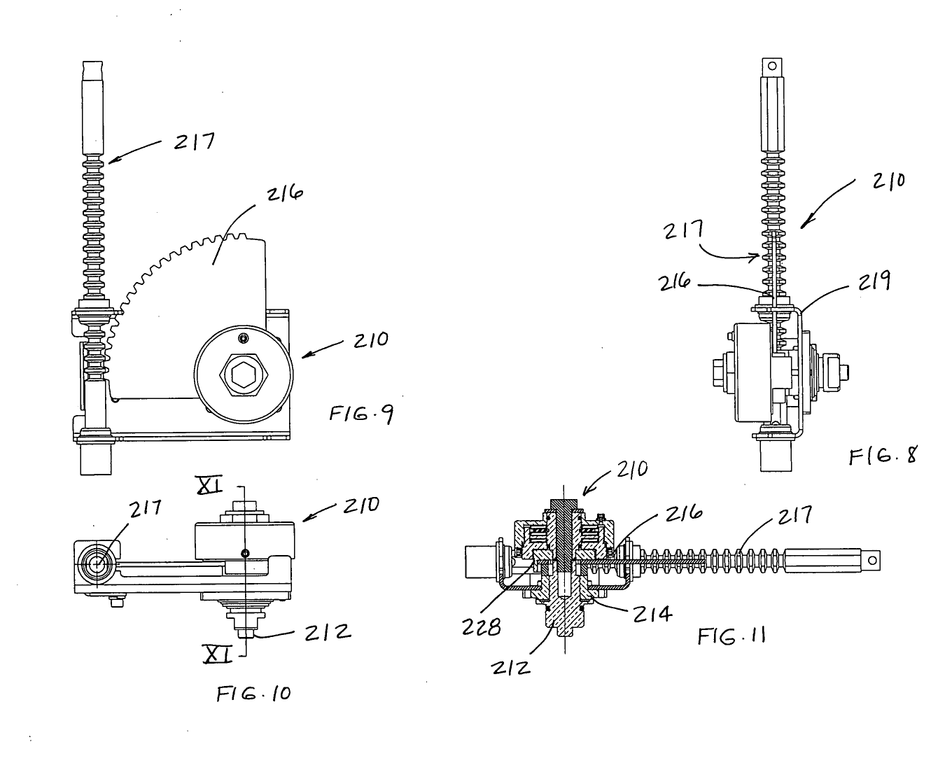

Referring to FIGS. 8-11, the numeral 210 references another embodiment of the actuator assembly, which comprises a rack and sector actuator assembly and is driven by a rack 217 and a sector gear 216. Again, actuator assembly 210 is of similar construction to actuator assembly 10 but rather than including a handle 16 includes a sector gear 216 mounted about actuator 212. Similar to handles 16 and 116, sector gear 216 extends through an opening provided in member 228 for engagement by a rack 217.

Rack 217 and sector gear 216 are supported by a modified adapter 214 on a bracket 219. Adapter 214 provides a step or shoulder 214a to accommodate bracket 219, which is mounted about adapter 214. For further details of the actuator assembly (and its slow close assembly), reference is made to actuator assembly 10.

Changes and modifications to the specifically described embodiments may be carried out without departing from the principles of the present invention, which is intended to be limited only by the scope of the appended claims as interpreted according to the principles of patent law including the doctrine of equivalents.

We claim:

1. A valve comprising:
a valve body with a passageway;
a valve closure member in said passageway and being mounted for movement between a closed position wherein said valve closure member blocks flow though the passageway and an open position wherein said passage is open for fluid flow;
an actuator engaging the valve closure member; and
a slow close assembly, said slow close assembly comprising:
a housing having a chamber; and
at least one friction member retained in said chamber and coupled to said actuator, said friction member generating a friction force in said chamber when said actuator is moved to thereby limit the speed at which the actuator may be moved.

2. The valve according to claim 1, wherein said friction member comprises a friction disc.

3. The valve according to claim 2, said slow close assembly comprising a plurality of friction discs.

4. The valve according to claim 2, further comprising a resilient disc positioned adjacent said friction disc, wherein said friction generated by said friction disc may be adjusted by said resilient disc.

5. The valve according to claim 4, wherein said resilient disc comprises a rubber disc.

6. The valve according to claim 4, wherein said slow close assembly is configured without internal stops, wherein said slow close mechanism is adapted to rotate independent of any internal mechanical stops.

7. The valve according to claim 6, wherein said slow close assembly comprises a sealed assembly.

8. A valve comprising:
a valve body with a passageway;
a valve closure member in said passageway and being mounted for movement between a closed position wherein said valve closure member blocks flow though the passageway and an open position wherein said passage is open for fluid flow;
an actuator engaging the valve closure member; and
a slow close assembly, said slow close assembly comprising:
a housing having a fluidly sealed chamber; and
said chamber being adapted to provide resistance to the movement of said actuator to thereby limit the speed at which the actuator may be moved.

9. The valve according to claim 8, wherein said chamber is configured without internal stops.

10. The valve according to claim 8, wherein said slow close assembly includes at least one friction member in said chamber coupled to said actuator, said friction member being adapted to generate friction when said actuator moves to thereby provide resistance to the movement of said actuator.

11. The valve according to claim 10, wherein said slow close assembly includes a plurality of said friction members in said chamber.

12. The valve according to claim 11, further comprising a resilient member positioned adjacent at least one of said friction members, wherein said friction generated by said friction member may be adjusted by said resilient member.

13. A valve comprising:
a valve body with a passageway;
a valve closure member in said passageway and being mounted for movement between a closed position wherein said valve closure member blocks flow though the passageway and an open position wherein said passage is open for fluid flow;
an actuator engaging the valve closure member; and
a slow close assembly, said slow close assembly comprising:
a housing having a chamber; and
said chamber being adapted to provide resistance to the movement of said actuator to thereby limit the speed at which the actuator may be moved, and said slow close assembly being configured without any internal stops.

14. The valve according to claim 13, wherein said slow close assembly includes at least one friction member in said chamber coupled to said actuator, said friction member being adapted to generate friction when said actuator moves to thereby provide resistance to the movement of said actuator.

15. The valve according to claim 14, wherein said slow close assembly includes a plurality of said friction members in said chamber.

13. The valve according to claim 14, further comprising a resilient member positioned adjacent said friction member, wherein said friction generated by said friction member may be adjusted by said resilient member.

14. An adjustable mechanical device for controlling closure of a valve closure member of a valve, comprising:
an adapter for mounting to a valve;
an actuator for engaging the valve closure member; and
a slow close assembly for mounting to said adapter, said slow close assembly comprising:
at least one friction member coupled to said actuator, said friction member generating a friction force when said actuator is rotated to thereby limit the speed at which said actuator may be rotated.

15. The adjustable mechanical device according to claim 14, further comprising a handle coupled to the adapter, said handle adapted to rotate said actuator about an axis for opening, closing or throttling the valve.

16. The adjustable mechanical device according to claim 14, wherein said friction member comprises a friction disc.

17. The adjustable mechanical device according to claim 16, wherein said slow close device includes a chamber having a first wall, said friction disc being captured in said chamber and generating friction with said first wall.

18. The adjustable mechanical device according to claim 17, wherein said chamber has a second wall, said device further comprising at least two friction discs captured in said chamber, one of said discs generating friction with said first wall, and another of said discs generating friction with said second wall.

19. The adjustable mechanical device according to claim 18, further comprising a resilient disc positioned adjacent one of said friction discs, wherein said friction generated by said one of said friction discs may be adjusted by said resilient disc.

20. The adjustable mechanical device according to claim 14, wherein said slow close assembly is mounted independent of internal stops, wherein said slow close mechanism is adapted to rotate degrees without interference from internal mechanical stops.
